(19) United States
(12) Patent Application Publication
(10) Pub. No.: US 2008/0302724 A1
(43) Pub. Date: Dec. 11, 2008

(54) METHOD AND APPARATUS FOR REMOVING IMPURITIES IN REJECTS FROM SEQUENTIAL FILTERS USING SEPARATE TREATMENT UNITS

(75) Inventors: Brett Hunt Boyd, Coral Springs, FL (US); Walter Andrew Molawka, Boca Raton, FL (US); Dominic Edgar Janssen, North Lauderdale, FL (US)

Correspondence Address: FOLEY AND LARDNER LLP;SUITE 500, 3000 K STREET NW, WASHINGTON, DC, 20007, US

(73) Assignee: Parkson Corporation

(21) Appl. No.: 11/966,033

(22) Filed: Dec. 28, 2007

Related U.S. Application Data
(63) Continuation of application No. 11/745,945, filed on May 8, 2007.
(60) Provisional application No. 60/799,003, filed on May 10, 2006.

(51) Int. Cl. B01D 29/56; B01D 61/14; B01D 35/22; B01D 24/46; B01D 37/00

(52) U.S. Cl. 210/650; 210/284; 210/779; 210/335; 210/333.1

(57) ABSTRACT

The disclosed method and apparatus involves the use of sequential filters for the purification of liquid. The sequential filters may each produce rejects that can be processed separately in their respective treatment apparatus, which can be fine-tuned to the specific reject that it treats. Alternatively, the first reject may be treated while the second reject may not be treated. The rejects (whether treated or not) may be combined into a combined flow and then be recycled in the sequential filters.

### CROSS-REFERENCE TO RELATED APPLICATIONS

This application is a continuation of U.S. patent application Ser. No. 11/745,945 filed May 8, 2007, which claims priority to U.S. Provisional Application No. 60/799,003 filed May 10, 2006, the entire disclosures of which are incorporated herein by reference.

### BACKGROUND

The present invention relates to the treatment of water/wastewater, and more particularly, to a method and apparatus for removing impurities and/or pollutants from the water/wastewater by separately treating the rejects from each stage of a two-stage continuously operated granular media filtration system.

In connection with many municipal and industrial water treatment systems, the water/wastewater needs to be purified. One example can be a drinking water system in which drinking water is produced from surface water. Another example may be a municipal wastewater treatment system in which the wastewater needs to be treated so that it can be discharged or reused for industrial, irrigational, or similar purposes. In order for such treated water to be useful, pathogens, protozoans, phosphorus and other pollutants need to be removed from the wastewater. Moreover, organisms, such as Cryptosporidium and Giardia and their oocysts and/or cysts, need to be removed from the water/wastewater (hereinafter referred to as wastewater although any kind of water or liquid with impurities can be treated by the apparatus and method of the present disclosure).

In a purification process, the wastewater can be subjected to precipitation and/or flocculation. In this regard, conventional chemical treatment can include one or more flocculation tanks in which the wastewater is agitated with stirrers or agitators. Thereafter, the wastewater passes through one or more sedimentation basins after appropriate chemicals have been added. One of the disadvantages of conventional chemical treatment processes is the large area required for the flocculation tanks and sedimentation basins. A further disadvantage of conventional chemical treatment techniques is the long time that the water needs to remain in the flocculation tank as well as the sedimentation basin.

The use of flocculation tanks and sedimentation basins alone in the chemical treatment process does not typically result in a high enough water purity for many applications. A granular media filter, for example, can be added at the end of the chemical treatment step to increase the purity of the water being treated. The sand in such filters must also be cleaned. In some such filters, the sand is cleaned by back-washing it at frequent intervals. In order to avoid shutting down the filtration step, it may be necessary to provide at least two sand filters, in parallel, where one of which is in use while the other is being back-washed.

The use of two different, separately operated sand filters can be avoided if a continuously operated sand filter of the type disclosed in U.S. Pat. Nos. 4,126,546 and 4,197,201 is utilized. In such a sand filter, the filter bed is continuously cleaned while the filter is in operation. In this regard, the dirtiest sand is taken out of the filter bed, washed, and returned to the clean part of the sand bed. In this way, the filter does not have to be taken out of operation for back-washing. A similar type of continuously operating sand filter also is disclosed in U.S. Pat. No. 4,246,102. As disclosed in that patent, the liquid is treated with chemicals before being treated in the sand filter.

As is indicated in U.S. Pat. No. 4,246,102, the use of a continuously operating sand filter with chemical treatment makes it possible to reduce the volume of liquid retained in the filtration step to about one-tenth of that required for conventional processes. As a result, the area required for that step is reduced and the rate at which liquid passes through the filtration step is increased.

In order to further increase the purity level of the water being treated, two continuously operated sand filters can be operated in series with the filtrate exiting the first sand filter and being introduced as the input of the second sand filter. Such serial sand filters have been operated successfully but the amount of reject from those filters and the amount of impurities in that reject makes it difficult and costly to dispose of the reject.

Another example of a sand filter application is the wastewater management system disclosed in U.S. Pat. No. 5,843,308. This system includes two continuously operated sand filters that are operated in series in order to eliminate or substantially reduce phosphorus, pathogens and protozoans (for example, Cryptosporidium and Giardia).

The reject water from the second sand filter is returned to the influent of the first sand filter and the reject water from only the first sand filter is directed to waste.

Another example of a wastewater treatment system is disclosed in U.S. Pat. No. 6,426,005 in which two continuously operating granular media filters are operated together in series. In this patent, the wastewater to be treated is introduced as an influent into a first granular media filter and is treated therein. The first filter produces treated, processed wastewater or effluent and a first reject that contains impurities separated from a granular media bed in the first granular media filter. The effluent from the first filter is further filtered in the second continuously operating granular media filter to produce a final effluent. A second reject discharged from the second granular media filter contains impurities separated from a granular bed in the second granular media filter. In order to reduce the pollutants in the first and second rejects, the first and second reject water are combined for at least one treatment stage.

One drawback to U.S. Pat. No. 6,426,005 is that the first and second rejects may have different chemical compositions or levels of impurity, which may require different treatment methods. Thus, there is a need to improve the treatment of the first and second rejects such that the treatment can be fine-tuned for the characteristics of each reject stream.

Accordingly, it is an object of the present disclosure to provide a new and improved method and apparatus for the treatment of wastewater or other liquid.

It is another object of the present disclosure to provide a new and improved method and apparatus for the treatment of wastewater or other liquid to remove pollutants (for example, pathogens, protozoans, and phosphorus) from the wastewater or other liquid being treated and thereafter separately treating those pollutants.

It is still another object of the present disclosure to provide a new and improved method and apparatus for the treatment of wastewater or other liquid in which impurities and/or pollutants are separated from the wastewater or other liquid in a pair of filters, such as sand filters, operated continuously in series and the rejects from each of the filters are separately treated.

### SUMMARY OF THE INVENTION

One embodiment of the present invention is a method for treating a liquid having impurities, which may comprise: feeding a liquid having impurities as a first influent to a first filter; filtering the first influent in the first filter to produce a first effluent and a first reject; feeding the first effluent as a second influent to a second filter; filtering the second influent in the second filter to produce a second effluent and a second reject; subjecting the first reject to a first reject treatment to produce a first treated reject; subjecting the second reject to a second reject treatment to produce a second treated reject; combining the first treated reject and the second treated reject to provide combined treated rejects; and feeding the combined treated rejects into said first filter, e.g., blending the combined treated rejects with the first influent.

The first and second filters may be continuously backwashed upflow granular media filters or may be any other known type of filter. In another embodiment, if granular media filters are used, sand may be used as a filter medium in each of said first and second granular media filters.

The first and second reject treatments may comprise the same or different treatments. In addition, the first and second reject treatments may comprise treatments selected from the group consisting of gravity separation, filtration, two stage or multistage filtration, membrane filtration and combinations thereof.

In another embodiment of the present invention, a method for treating a liquid having impurities may comprise: feeding a liquid having impurities as a first influent to a first filter; filtering the first influent in the first filter to produce a first effluent and a first reject; feeding the first effluent as a second influent to a second filter; filtering the second influent in the second filter to produce a second effluent and a second reject; subjecting the first reject to a first reject treatment to produce a first treated reject; combining the first treated reject and the second untreated reject to provide combined treated and untreated rejects; and feeding the combined treated and untreated rejects into the first filter, e.g., blending the combined treated and untreated rejects with said first influent.

The first and second filters may be continuously backwashed upflow granular media filters or may be any known type of filter. In addition, the first reject treatment may comprise a treatment selected from the group consisting of gravity separation, filtration, two stage or multistage filtration, membrane filtration and combinations thereof.

In yet another embodiment of the present invention, an apparatus for treating a liquid having impurities may comprise: a first filter, a second filter, a treatment unit, and a combination unit. The first filter can comprise a first filter inlet allowing inflow of a liquid having impurities as a first influent, a first filter outlet allowing outflow of a first effluent, and a second filter outlet allowing outflow of a first reject. The second filter can comprise a second filter inlet in fluid communication with the first filter outlet of the first filter allowing inflow of the first effluent as a second influent, a third filter outlet allowing outflow of a second effluent, and a fourth filter outlet allowing outflow of a second reject. The treatment unit may comprise a treatment inlet in fluid communication with the second filter outlet of the first filter and a treatment outlet allowing outflow of a treated reject. The combination unit may comprise one or more combination inlets in fluid communication with the treatment outlet of the treatment unit and the fourth filter outlet of the second filter and at least one combination outlet in fluid communication with the first filter inlet of the first filter allowing outflow of combined rejects into the first filter, e.g., the outflow of the combined rejects can be blended with the first influent.

In another embodiment, a second treatment unit may be provided which can comprise a second treatment inlet in fluid communication with the fourth filter outlet of the second filter and a second treatment outlet allowing outflow of a second treated reject. The second treatment outlet can be in fluid communication with at least one combination inlet of the combination unit and the at least one combination outlet allows outflow of the combined treated rejects. The first and second treatment units can be of similar types or of different types.

In one embodiment, the first and second filters are continuously backwashed upflow granular media filters but other known types of filters can be used.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a perspective view of a prior art continuously operated sand filter for treating wastewater with a portion of the outer housing cut away so that the operation of the sand filter can be discerned.

FIG. 2 shows a schematic structure of a wastewater treatment system according to one embodiment of the present invention.

FIG. 3 shows a schematic structure of a wastewater treatment system according to another embodiment of the present invention.

FIG. 4 shows a schematic structure of a wastewater treatment system with an additional mechanical treatment apparatus according to an embodiment of the present invention.

FIG. 5 shows a schematic structure of a wastewater treatment system with additional mechanical and biological treatment apparatuses according to an embodiment of the present invention.

FIG. 6 shows a schematic structure of a water/waste treatment system with additional mechanical, biological, and chemical treatment apparatuses according to an embodiment of the present invention.

FIG. 7 shows a schematic structure of a wastewater treatment system with an additional mechanical treatment apparatus according to another embodiment of the present invention.

FIG. 8 shows a schematic structure of a wastewater treatment system with additional mechanical and biological treatment apparatuses according to another embodiment of the present invention.

FIG. 9 shows a schematic structure of a water/waste treatment system with additional mechanical, biological, and chemical treatment apparatuses according to another embodiment of the present invention.

### DETAILED DESCRIPTION

Various embodiments of the present invention will be explained with reference to the accompanying drawings.

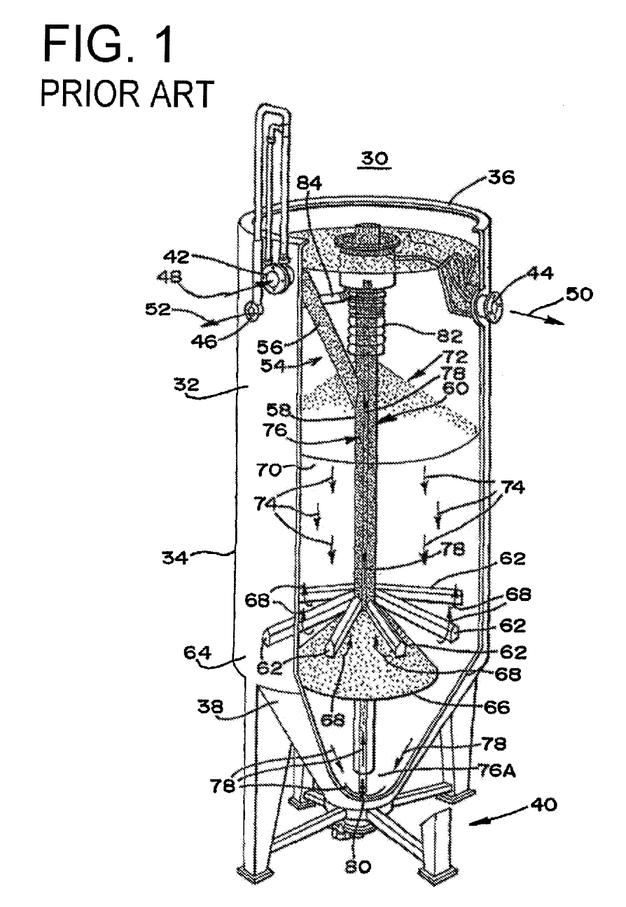

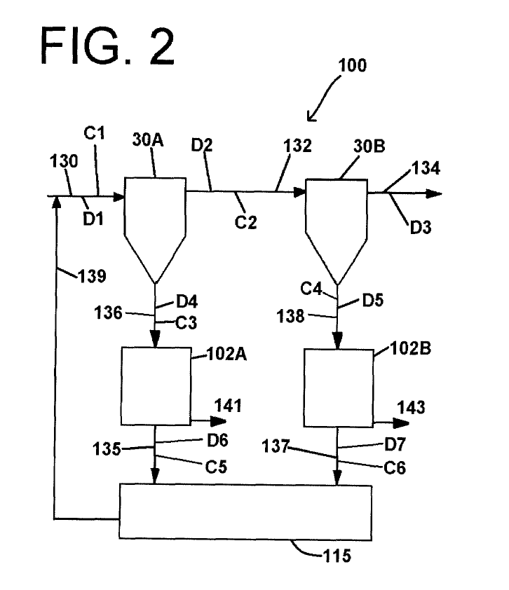

FIG. 1 shows a prior art continuously operating sand filter 30 used in treating wastewater. Such a sand filter 30 is of the general type disclosed in U.S. Pat. Nos. 4,126,546; 4,197,201; 4,246,102; and 6,426,005, the disclosures of which are incorporated herein by reference. As is discussed hereinafter, two such sand filters 30 can be operated in series together with a separate treatment device for each filter, for example, as shown in FIG. 2.

The sand filter 30 includes an outer housing or tank 32 having an outer, generally cylindrically shaped wall 34 extending from a top end 36 to a funnel-shaped bottom portion 38. The tank 32 is supported by a stand assembly 40 so that the tank 32 can be disposed in a vertical orientation as shown in FIG. 1 of the drawings with the stand assembly 40 extending downward from the outer wall 34 and around the funnel-shaped bottom portion 38. The sand filter 30 includes an inlet port 42 and outlet ports 44 and 46. As indicated by an arrow 48, untreated wastewater is introduced into the tank 32 of the sand filter 30 through the inlet port 42. An arrow 50 indicates how the treated wastewater is discharged from the outlet port 44 while an arrow 52 indicates how the reject from the sand filter 30 is discharged from the outlet port 46

The wastewater to be treated (the influent) is introduced through the inlet port 42 and flows into the inlet port 42 in the direction of the arrow 48. The influent flows from the inlet port 42 through an inlet or feed duct 54 that includes a diagonally oriented duct portion 56 and a vertically oriented duct portion 58 that extends concentrically about a central vertical riser 60. The influent flows through the feed duct 54 to distribution hoods 62 (only six of the distribution hoods 62 are illustrated in the sand filter 30 shown in FIG. 1, but the sand filter 30 will typically include eight such distribution hoods 62 distributed equally around the riser 60) that extend radially from the riser 60 near a lower portion 64 of the wall 34 and just above or through an upper part of a funnel-shaped hood 66. The influent is discharged into the tank 32 from the lower portions of the distribution hoods 62 as is represented by arrows 68. A sand bed 70 includes a filter medium that fills the tank 32 from the bottom funnel-shaped portion 38 to approximately a level generally indicated by the reference numeral 72. The discharging of the influent from below the distribution hoods 62 tends to prevent the filter medium from coming in direct contact with outlets in the distribution hoods 62. By this arrangement, the risk of clogging of the outlets in the distribution hoods 62 by the filter medium close to the outlets is reduced. As further indicated by the arrows 68, the influent will rise upward in the tank 32 so that it flows through the sand bed 70.

The influent being discharged from the distribution hoods 62 rises through the sand bed 70 and filtration of the influent takes place as the filter medium is traveling slowly downward in the tank 32 as indicated by arrows 74. The arrangement of the distribution hoods 62 in the lower part of the filter bed 70 has the advantage that most of the suspended solids in the influent will be separated near the level at which the distribution hoods 62 are disposed. As a result, the most dirty portion of the filter medium continues downwards and is no longer utilized in the filtration process until it has been cleaned.

The slow downward movement of the filter medium in the sand bed 70 is caused by an air-lift pump 76 that extends in the riser 60. Compressed air is supplied to an air lift chamber at 76A of the air-lift pump 76 near the bottom of the riser 60 through an air supply line (not shown) extending down through the riser 60. The air is introduced into the air-lift pump 76 from the air chamber at 76A. The air lift pump 76 will contain a mixture of liquid, air and granular filter medium during operation thereof. The mixture of liquid, air and granular filter medium has a lower density than the surrounding liquid causing the mixture to rise in the air-lift pump 76. As this mixture rises in the air-lift pump 76, filter medium and liquid near the bottom of the bed 70 in the funnel-shaped bottom portion 38 of the tank 32 will flow as indicated by arrows 78 through an inlet 80 of the air-lift pump 76 extending out of the lower part of the riser 60. By having the inlet 80 near the bottom of the tank 32, the dirtiest of the filter medium tends to flow into and upward in the air-lift pump 76.

As the dirty filter medium (sand) flows upward in the air-lift pump 76, the sand is subjected to a thorough mechanical agitation by the action of the air bubbles within the air-lift pump 76 and the dirt is separated from the grains of sand. The mechanical agitation and turbulence created by the action of the air bubbles in the air-lift pump 76 is so intense that some microorganisms will be killed by such action. In order to further clean the sand particles, the sand is washed in a washer 82 which is located near the top end of the riser 60 and disposed concentrically around the air-lift pump 76. The cleaned sand from the washer 82 is returned to the top of the sand bed 70 whereas the reject from the washer 82 flows from the washer 82 through a discharge duct 84 so as to be discharged through the outlet port 46 as indicated by the arrow 52. On the other hand, the treated water or filtrate flows as an overflow near the top 36 of the tank 32 and is discharged as an effluent through the outlet port 44 as indicated by the arrow 50.

Sand filters of the type of the sand filter 30 illustrated in FIG. 1 have been used in series in situations where a higher degree of purification/filtration is desired than that obtained from one such sand filter 30. However, an even higher level of purification can be obtained if the sand filters of the type of the sand filter 30 is used in the wastewater treatment system 100, which is schematically shown in FIG. 2. The wastewater treatment system 100 includes a first sand filter 30A and a second sand filter 30B, each of which is essentially identical to the sand filter 30 illustrated in FIG. 1, and two separate treatment apparatuses 102A and 102B.

In the particular wastewater treatment system 100 illustrated in FIG. 2, two sand filters 30A and 30B are disclosed, but it should be understood that in connection with the present invention any suitable type of filter can be used in place of either or both of the sand filters 30A and 30B, for example, a traveling bridge filter or other type of rapid gravity filter. Indeed, the first and second filters 30A and 30B can be of the same type, such as they can both be continuously backwashed upflow granular media filters, or they can be different types. If granular media filters are used, the filter may utilize a bed of sand, crushed granite or other material suitable for filtering water or the like.

In the wastewater treatment system 100, there are two filters 30A and 30 B that are operated continuously in series. The sand filters 30A and 30B are of similar design to the sand filter 30. The wastewater to be treated flows through an inlet duct as schematically shown by arrow 130. The wastewater flows from the inlet conduct into an inlet port of the first sand filter 30A (arrow 130). The influent can be treated within that first sand filter 30A in the same manner that the wastewater is treated in the sand filter 30 in FIG. 1. As a result, a first treated wastewater or effluent and a first reject containing impurities separated from the sand bed in the first sand filter 30A are produced. This first effluent flows through an outlet port into a linking duct as schematically shown by an arrow 132. The linking duct couples the outlet port of the first filter 30A to an inlet port of the second sand filter 30B. As a result, the first effluent being discharged from the sand filter 30A flows through the linking duct and into the inlet port of the second filter 30B as a second influent for the second sand filter 30B. On the other hand, the first reject from the first sand filter 30A is discharged from an outlet port into a first reject duct as indicated by an arrow 136. The first reject duct is in fluid communication with an input duct of the first separate treatment apparatus 102A so that the first reject from the filter 30A flows to the first separate treatment apparatus 102A.

The second influent flowing into the inlet port of the second sand filter 30B as indicated by arrow 132 is treated within the second sand filter 30B in the same manner that the wastewater is treated in the sand filter 30 of FIG. 1. As a result, a second treated wastewater or effluent and a second reject containing impurities separated from the sand bed in the second sand filter 30B are produced. The second effluent is discharged through an outlet port of the second filter into an outlet duct as indicated by an arrow 134 so that the purified liquid being discharged through the outlet duct can be used, for example, as drinking water if the first influent is from surface water or can be used in industrial, irrigation, or other similar purposes if the first influent is from a municipal wastewater treatment facility. On the other hand, the second reject from the second sand filter 30B is discharged through an outlet port into a second reject duct as indicated by an arrow 138. The second reject duct is in fluid communication with the input duct of a second separate treatment apparatus 102B.

The filters 30A and 30B can be free-standing units supported on stand assemblies 40A and 40B respectively, such as the one seen in FIG. 1. Alternatively, the filters 30A and 30B can be multiple modules within a filter, such as a concrete tank in which multiple filter modules are disposed. Moreover, the filters 30A and 30B can be two different heights with the second filter 30B being of a somewhat different, lesser height so that, as the effluent from the first filter 30A exits the outlet port of the first filter, it will flow in the duct to the inlet port of the second filter 30B (arrow 132). This difference in the levels of the outlet port of the first filter and the inlet port of the inlet port of the second filter eliminates the necessity of having to pump the effluent in the duct between the outlet port of the first filter and the inlet port of the second filter (along arrow 132). On the other hand, the filters 30A and 30B can be of the same size but the filter 30A would be positioned at a higher level than the filter 30B. Alternatively, a pump can be used to move the liquid though the conduit from the outlet port of the first filter to the inlet port of the second filter.

The sand beds of the first and second filters 30A and 30B may be of different depths and may have different types or sizes of filter media. In fact, the filter media for the two filters 30A and 30B may be chosen independently. For example, if sand beds are used, the filter media in the sand beds may be silica sand. Each of the sand beds may include sand of the same or different particle sizes (for example, the filter media in the first sand filter 30A may have a bigger particle size than the filter media in the second sand filter 30B) and may be of the same or different density (for example, the filter media in the first sand filter 30A may have a lower density than the filter media in the second sand filter 30B). On the other hand, the filter media in the first sand filter 30A may be silica sand and the filter media in the second sand filter 30B may be garnet. In addition and as is discussed further hereinafter, the first influent prior to its introduction into the inlet port of the first sand filter 30A may be mechanically treated; chemically treated with chemicals for coagulation/flocculation; and/or biologically treated.

As previously indicated, the first reject from the first sand filter 30A is introduced into the first separate treatment apparatus 102A through an input duct (arrow 136) while the second reject from the second sand filter 30B is introduced into the second separate treatment apparatus 102B through another input duct (arrow 138). The first and second rejects are processed in these separate treatment apparatuses so as to ensure that the pollutants separated from the wastewater being treated in the first and second serial filters 30A and 30B are subjected to a renewed treatment and/or separate treatment. However, the output of the first and second treatment apparatuses 102A and 102B may not be suitable for discharge from the system as clean water that meets quality standards. Thus, the effluent from the first treatment apparatus 102A, or the first treated reject, is discharged into a conduit (arrow 135) that is connected to a combination unit 115. Furthermore, the effluent from the second apparatus 102B, or the second treated reject, is discharged into a conduit (arrow 137) that is connected to the combination unit 115. Meanwhile, the first and second treatment apparatuses 102A and 102B may also discharge sludge into conduits as indicated by arrows 141 and 143 respectively. These sludge flows can be dewatered and/or processed by suitable hygienic measures (e.g., sterilization).

In regard to the first and second separate treatment apparatuses 102A and 102B, these different units allow a more fine-tuned treatment for each of the reject streams. For example, the first reject will likely have more impurities than the second reject. Thus, it is possible, for example, to have the first reject undergo a clarification process as its treatment process while the second reject merely needs to undergo a filtering process. In the example shown in FIG. 2, in the first treatment apparatus, the first treated reject produced in the first separate treatment apparatus 102A is discharged to an outlet duct (arrow 135) whereas the sludge is discharged to a discharge duct (arrow 141). In the second treatment apparatus, the second treated reject produced in the second separate treatment apparatus 102B is discharged into an outlet duct (arrow 137) whereas the sludge is discharged into a discharge duct (arrow 143). Alternatively, one or both of the first and second treatment processes in the first and second treatment apparatuses 102A and 102B may not result in a discharged sludge flow. If there is no discharged sludge, there would be no outlet conduits connected to the treatment apparatuses 102A and 102B (thus, no arrows 141 and 143 as depicted in FIG. 2) but only outlet conduits for the treated rejects (arrows 135 and 137).

The treatment for the two separate treatment apparatuses 102A and 102 B for the first and second reject water may consist of gravity separation, membrane filtration, two stage or multistage filtration or filtration or any combination thereof. The particular treatment for each treatment apparatus that is selected can be dependent on ensuring that the treatment will produce a treated reject of the desired quality in which it is suitable for its re-introduction into the system as part of the influent into the filter 30A without significantly degrading the overall performance of the first and second filters. The treatment selected for the first separate treatment apparatus 102A may be of the same type as the treatment selected for the second separate treatment apparatus 102B, for example, both can be membrane filtration. On the other hand, it is possible for the first treatment to be different from the second treatment. For example, the first treatment apparatus can be of a gravity separation type while the second treatment apparatus can be of a membrane filtration type.

In addition, the first and second treatment apparatuses 102A and 102B can be positioned within a singular housing or two separate housings. For example, if the two rejects would utilize the same treatment, a concrete basin with a center wall to separate the two reject flows could be used. In another embodiment, there could be two pieces of half-capacity equipment rather than one piece.

After both the first and second rejects are treated in their respective treatment apparatuses, the two treated reject flows are combined into a combination unit 115. The combination unit can be a chamber, piping, or any structure or combination of structures that is used to merge two flows into a single flow. After the treated rejects are combined, this combined treated reject flow exits the combination unit 115 and enters into an outlet duct with a flow indicated by arrow 139, which is connected to the inlet duct leading to the first filter (arrow 130). The combined treated reject flow is introduced into the inlet duct leading to the first filter (arrow 130) so that the combined treated reject flow is introduced with the first influent prior to entering the first filter. A pump (not shown) may be used to inject the combined treated reject flow into the inlet duct leading to the first filter (arrow 130) if necessary.

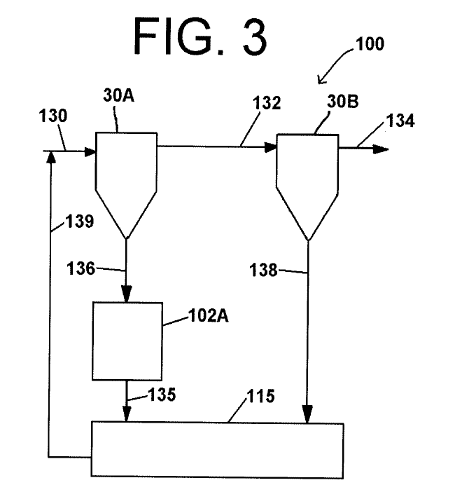

FIG. 3 shows another embodiment of the wastewater treatment system. As in FIG. 2, a first influent enters the first filter 30A though an inlet port (arrow 130). The outlet port of the first filter discharges the first effluent and enters the second filter 30B through an inlet port as a second influent (arrow 132). The first filter 30A also has a first reject that exits out of a port (arrow 136) and enters a treatment apparatus 102A. Meanwhile, the second influent enters into the second filter 30B and produces treated water, which discharges out of the outlet port (arrow 134). In addition, the second filter 30B also produces a second reject flow which enters into a second reject duct (arrow 138).

The first reject is treated in apparatus 102A by any means know in the art, such as apparatuses that employ gravity separation, filtration, two stage or multistage filtration, membrane filtration and combinations thereof, as was discussed in the embodiment of FIG. 2. The treatment of the first reject results in a first treated reject, which is discharged into an outlet duct (arrow 135). In contrast, the second reject is not treated but merely is discharged into a second reject conduit (arrow 138). The outlet duct from the treatment apparatus (arrow 135) and the second reject conduit (arrow 138) are connected to the combination unit 115 in which the first treated reject and the second untreated reject are combined into a single flow. The combination unit 115 can be a chamber, piping, or any structure that is used to merge two flows into a single flow. After the treated and untreated rejects are combined, this combined reject flow exits the combination unit 115 into an outlet duct (arrow 139), which is connected to the inlet duct leading to the first filter (arrow 130). The combined reject flow is introduced into the inlet duct leading to the first filter (arrow 130) so that the combined reject flow is introduced with the first influent for the first filter. As mentioned in the embodiment of FIG. 2, a pump (not shown) may be used to inject the combined treated reject flow into the inlet duct leading to the first filter, if necessary.

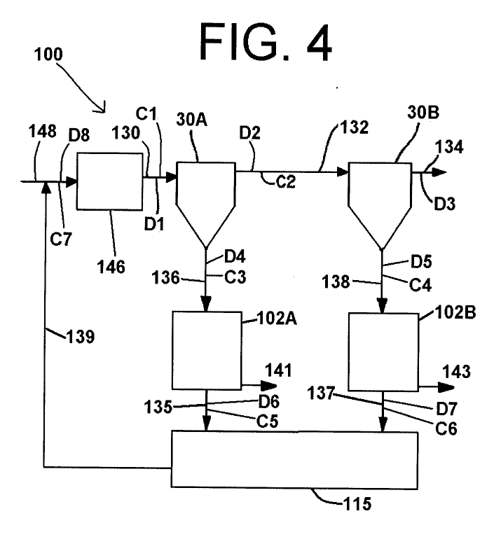

FIGS. 4-6 illustrate schematically additional processes that may be used in conjunction with the wastewater treatment system 100. In the case of FIG. 4, the first influent is subjected to a mechanical treatment prior to the first influent flowing into the first filter 30A as indicated by the arrow 130. The first influent flows into a mechanical treatment apparatus 146 as indicated by an arrow 148 prior to being introduced into the first filter 30A. The mechanical treatment apparatus 146 alternatively may be a sand trap and/or some type of screen and/or a settling device.

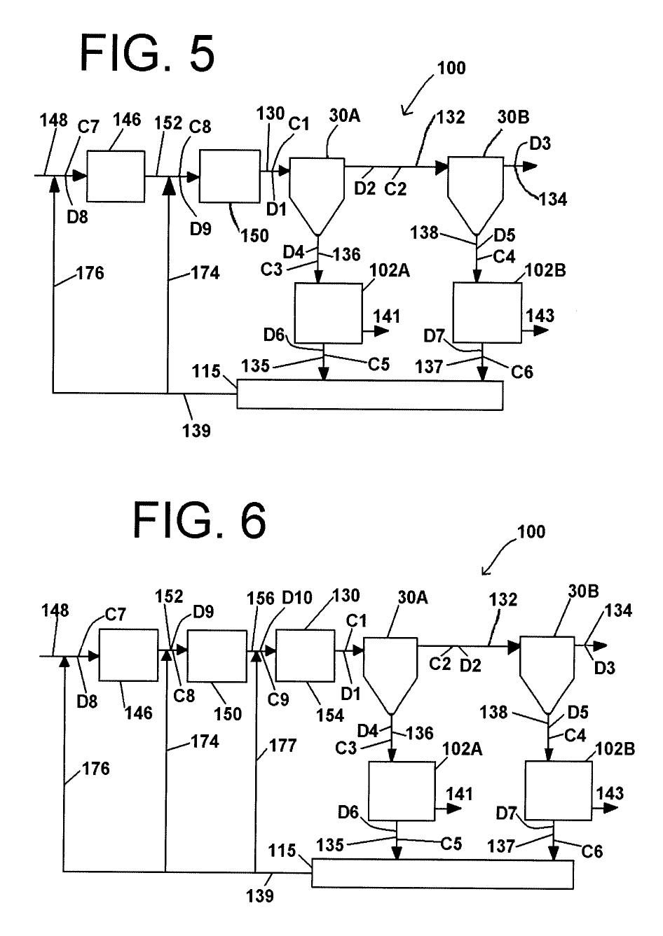

Between the mechanical treatment apparatus 146 and the first filter 30A, the first influent can be subjected to a biological treatment. As is illustrated in FIG. 5, the first influent flows into a biological treatment apparatus 150 as indicated by an arrow 152 after being mechanically treated in the mechanical treatment apparatus 146 and prior to being introduced into the first filter 30A. The combined reject flow being discharged from the combination unit 115 as indicated by arrow 139 can be introduced upstream of either the mechanical treatment apparatus 146 (as depicted by the arrow 176 which indicates that the combined reject flow can be combined with the influent as it is flowing into the mechanical treatment apparatus 146 as indicated by the arrow 148) or the biological treatment apparatus 150 (as depicted by the arrow 174 which indicates that the combined reject flow can be combined with the influent as it is flowing into the biological treatment apparatus 150 as indicated by the arrow 152).

In addition, the first influent can be chemically treated prior to its flowing into the filter 30A. In this regard, FIG. 6 illustrates schematically that a chemical treatment apparatus 154 can receive the first influent as it flows out of the biological treatment apparatus 150 as indicated by an arrow 156 but before it enters the first filter 30A. The combined reject flow being discharged from the combination unit 115 as indicated by arrow 139 can be introduced upstream of either the mechanical treatment apparatus 146 (as depicted by the arrow 176 which indicates that the combined reject flow can be combined with the influent as it is flowing into the mechanical treatment apparatus 146 as indicated by the arrow 148), the biological treatment apparatus 150 (as depicted by the arrow 174 which indicates that the combined reject flow can be combined with the influent as it is flowing into the biological treatment apparatus 150 as indicated by the arrow 152) or the chemical treatment apparatus 154 (as depicted by the arrow 177 which indicates that the combined reject flow can be combined with the influent as it is flowing into the chemical treatment apparatus 154 as indicated by the arrow 156).

In addition to the treatment of the wastewater by the first and second filters 30A and 30B in the wastewater treatment system 100, disinfection chemicals can be added to the liquids flowing into and out of the first and second filters 30A and 30B and the first and second separate treatment apparatuses 102A and 102B. The disinfection can be accomplished at any of the locations D1, D2, D3, D4, D5, D6, or D7 as indicated in FIG. 2. The disinfection can be carried out at any of the locations D1, D2, D3, D4, D5, D6, or D7 individually or in combination with the disinfection at one or more of the other locations (any combination of the disinfection locations is possible). In the cases where additional mechanical, biological and/or chemical treatment apparatus are provided upstream of the wastewater treatment system 100, disinfection can be accomplished at, for example, the location D8 in FIG. 4, the locations D8 and D9 in FIG. 5, and the locations D8, D9 and D10 in FIG. 6. In fact, the disinfection may take place at one or more of the indicated locations. The disinfection can be accomplished by any type of disinfection but disinfection agents, such as chlorine or any chlorine containing compound, ozone or any oxygen containing disinfectant or compound, or UV light, can be used.

In order to aid the filtering process of the wastewater treatment system 100, coagulation and/or flocculation chemicals can be added to the wastewater being treated in the wastewater treatment system 100. Again with reference to FIG. 2 of the drawings, the locations C1, C2, C3, C4, C5, and C6 are where such coagulation and/or flocculation chemicals can be added. The addition of such chemicals can be at any of the locations C1, C2, C3, C4, C5, and C6 individually or in combination with chemicals added at one or more of the other locations. In fact, any combination of the chemicals addition locations is possible. In the cases where additional mechanical, biological and/or chemical treatment apparatus are provided upstream of the wastewater treatment system 100, coagulation and/or flocculation chemicals also can be added. In this regard, the location C7 in FIG. 4, the locations C7 and C8 in FIG. 5, and the locations C7, C8 and C9 in FIG. 6 indicate further locations where chemicals can be added to the wastewater that is to be treated in the wastewater treatment system 100. In fact, the addition of such chemicals may take place at one or more of the indicated locations. Moreover, pH-adjusting chemicals may be added to the liquid prior to the addition of the coagulation and/or flocculation chemicals irrespective of which additional location or locations are chosen.

FIGS. 3 and 7-9 show other embodiments of the wastewater treatment system in which the first reject is treated in the treatment apparatus 102A while the second reject is not so treated. In regards to the first filter 30A, the treated wastewater (or the first effluent) enters into the second filter 30B as a second influent as indicated by the arrow 132 while the first reject enters the treatment apparatus 102A as indicated by the arrow 136. The second filter 30B receives the second influent and produces treated wastewater (or the second effluent) as indicated by the arrow 134 and a second reject, which is discharged as indicated by the arrow 138. The treated and untreated flows are combined together in the combination unit 115. Next, the combined flow exits the combination unit 115 as indicated by the arrow 139 and is inputted into the influent of the first filter 30A. Although it is not indicated in FIGS. 3 and 7-9, the first treatment apparatus 102A may have a sludge flow that exits the first treatment apparatus, which can be dewatered and/or processed by suitable hygienic measures (e.g., sterilization).

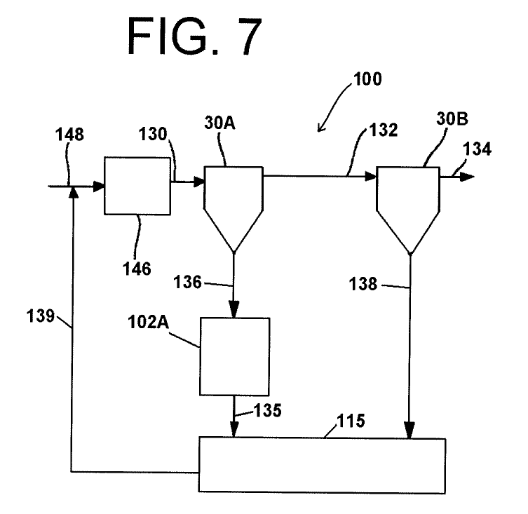

As shown in FIG. 7, the system can include a mechanical treatment apparatus 146 through which the influent flows and in which the influent is treated before being introduced into the first filter 30A. The combined reject flow indicated by the arrow 139 is merged upstream of where the influent is introduced into the mechanical treatment apparatus 146 as is indicated by the arrow 148.

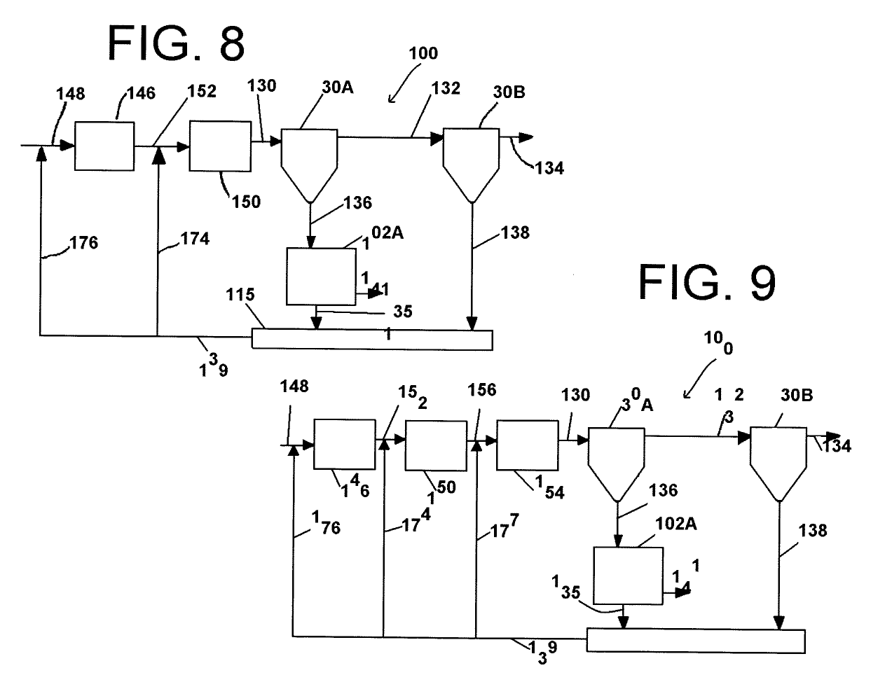

As depicted in FIG. 8, the influent flows through and is treated in a mechanical treatment apparatus 146 and a biological treatment apparatus 150 before it is introduced into the first filter 30A. As in the case of FIG. 5, the combined reject flow being discharged from the combination unit 115 as indicated by arrow 139 can be introduced upstream of either the mechanical treatment apparatus 146 (as depicted by the arrow 176 which indicates that the combined reject flow can be combined with the influent as it is flowing into the mechanical treatment apparatus 146 as indicated by the arrow 148) or the biological treatment apparatus 150 (as depicted by the arrow 174 which indicates that the combined reject flow can be combined with the influent as it is flowing into the biological treatment apparatus 150 as indicated by the arrow 152).

In the case of the system depicted in FIG. 9, the influent flows through and is processed in a mechanical treatment apparatus 146, a biological treatment apparatus 150, and a chemical treatment apparatus 154 before it is introduced into the first filter 30A. As in the case of FIG. 6, the combined reject flow being discharged from the combination unit 115 as indicated by arrow 139 can be introduced upstream of either the mechanical treatment apparatus 146 (as depicted by the arrow 176 which indicates that the combined reject flow can be combined with the influent as it is flowing into the mechanical treatment apparatus 146 as indicated by the arrow 148), the biological treatment apparatus 150 (as depicted by the arrow 174 which indicates that the combined reject flow can be combined with the influent as it is flowing into the biological treatment apparatus 150 as indicated by the arrow 152) or the chemical treatment apparatus 154 (as depicted by the arrow 177 which indicates that the combined reject flow can be combined with the influent as it is flowing into the chemical treatment apparatus 154 as indicated by the arrow 156).

Furthermore, in the case of the systems depicted in FIGS. 3 and 7-9, chemicals can be added and/or disinfection can be carried out at the various positions and in the various combinations as discussed above in connection with the systems depicted in FIGS. 2 and 4-6.

With the various embodiments of the present invention, there is the ability to treat the reject of one filter differently from the reject of another. This advantage can allow a fine-tuning of the treatment process for a particular reject, which can result in a higher efficiency in regards to the production of clean water. Lower manufacturing costs can also result since a reject may be allowed to undergo a less expensive form of treatment process while the other reject may still undergo a more expensive one.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A method for treating a liquid having impurities, comprising:
(a) feeding a liquid having impurities as a first influent to a first filter;
(b) filtering said first influent in said first filter to produce a first effluent and a first reject;
(c) feeding said first effluent as a second influent to a second filter;
(d) filtering said second influent in said second filter to produce a second effluent and a second reject;
(e) subjecting said first reject to a first reject treatment to produce a first treated reject;
(f) subjecting said second reject to a second reject treatment to produce a second treated reject;
(g) combining said first treated reject and said second treated reject to provide combined treated rejects; and
(h) feeding said combined treated rejects into said first filter.

2. The method of claim 1 in which the first and second filters are continuously backwashed upflow granular media filters.

3. The method of claim 1 in which sand is used as a filter medium in each of said first and second granular media filters.

4. The method of claim 1 in which the first and second reject treatments comprise the same treatment.

5. The method of claim 1 in which the first and second reject treatments comprise treatments selected from the group consisting of gravity separation, filtration, two stage or multistage filtration, membrane filtration and combinations thereof.

6. A method for treating a liquid having impurities, comprising:
(a) feeding a liquid having impurities as a first influent to a first filter;
(b) filtering said first influent in said first filter to produce a first effluent and a first reject;
(c) feeding said first effluent as a second influent to a second filter;
(d) filtering said second influent in said second filter to produce a second effluent and a second reject;
(e) subjecting said first reject to a first reject treatment to produce a first treated reject;
(f) combining said first treated reject and said second untreated reject to provide combined treated and untreated rejects; and
(g) feeding said combined treated and untreated rejects into said first filter.

7. The method of claim 6 in which the first and second filters are continuously backwashed upflow granular media filters.

8. The method of claim 6 in which the first reject treatment comprises a treatment selected from the group consisting of gravity separation, filtration, two stage or multistage filtration, membrane filtration and combinations thereof.

9. An apparatus for treating a liquid having impurities, comprising:
(a) a first filter comprising a first filter inlet allowing inflow of a liquid having impurities as a first influent, a first filter outlet allowing outflow of a first effluent, and a second filter outlet allowing outflow of a first reject;
(b) a second filter comprising a second filter inlet in fluid communication with the first filter outlet of the first filter allowing inflow of the first effluent as a second influent, a third filter outlet allowing outflow of a second effluent, and a fourth filter outlet allowing outflow of a second reject;
(c) a treatment unit comprising a treatment inlet in fluid communication with the second filter outlet of the first filter and a treatment outlet allowing outflow of a treated reject; and
(d) a combination unit comprising one or more combination inlets in fluid communication with the treatment outlet of the treatment unit and the fourth filter outlet of the second filter, and at least one combination outlet in fluid communication with the first filter inlet of the first filter allowing outflow of combined rejects into the first filter.

10. The apparatus of claim 9 which further comprises a second treatment unit comprising a second treatment inlet in fluid communication with the fourth filter outlet of the second filter and a second treatment outlet allowing outflow of a second treated reject, whereby the second treatment outlet is in fluid communication with at least one combination inlet of the combination unit and the at least one combination outlet allows outflow of combined treated rejects.

11. The apparatus of claim 10 in which the first and second treatment units are of similar types.

12. The apparatus of claim 9 in which the first and second filters are continuously backwashed upflow granular media filters.

13. The apparatus of claim 11 in which the first and second filters are continuously backwashed upflow granular media filters.
